(19) United States
(12) Patent Application Publication
(10) Pub. No.: US 2011/0270825 A1
(43) Pub. Date: Nov. 3, 2011

(54) Method and System for general matching and assignment between seekers and providers

(76) Inventor: Om Chand, Gilroy, CA (US)

(21) Appl. No.: 13/092,321

(22) Filed: Apr. 22, 2011

Related U.S. Application Data
(60) Provisional application No. 61/326,919, filed on Apr. 22, 2010.

(51) Int. Cl. G06F 17/30

(52) U.S. Cl. 707/723; 707/769; 707/E17.014

(57) ABSTRACT

The invention is a framework and a matching and assignment engine for connecting seekers with providers. It is meant for complex searches like job search, relationship search (dating), real estate search, car search etc. The system works by collecting attributes and weighted preferences from seekers and providers. The matching engine determines a match score based on match between the attributes and preferences of both the seeker and provider. The assignment engine then looks at the match scores and the supply and demand and assigns seekers to providers in a way that minimizes mismatch. The assignments change dynamically when supply and demand changes because of some event (a seeker or provider finds a match, a new seeker or provider becomes available, etc.). It is a web based software application.

### 1 RELATED PATENT APPLICATION

This patent application claims the benefit of the provisional patent application No. 61/326,919 titled ‘Method and System for general matching and assignment between seekers and providers’ which was filed on Apr. 22, 2010. It discloses the same invention as a non provisional patent.

### 2 FIELD OF INVENTION

The invention relates to web based software application for connecting seekers with providers. It addresses problems like job search, relationship search, real estate search, used car search.

### 3 BACKGROUND OF THE INVENTION

The existing web sites provide a way for seekers and providers to post their profiles (ads) and then both parties must search each other. For example, existing job web sites provide a way for job seekers to post their resumes and for employers post jobs. Then it allows seekers to search jobs and employers to search resumes. There are some controls to filter search results but they are not very effective. Recruiters must manually look at many resumes and pick candidates and on the other hand candidates must also look at many job descriptions to decide which jobs they should apply to. If the market is imbalanced (many seekers for every job or many jobs for every seeker), the search becomes even more painful for both parties. Either the employers have too many resumes (which cannot be browsed thoroughly) or too few resumes (they must look for more candidates). Both the employer and job seeker need to do these searches daily so as not to miss good candidates (or good jobs). The same approach is used for dating sites as well. Men and women have to continuously look at profiles to find the one that is compatible and then communicate with many of them to find the one who is interested in them. We observe that the current systems have the following disadvantages:
Supply and demand information is not used to make matches. Their search assumes that the items returned in search results are available (attainable). And this is not true for many situations—like jobs or relationships.
The attributes or preference information collected is not enough to make good matches and is fixed for all users. The users cannot add their unique attributes or preferences.
When new seekers or providers become available, there is no good way to inform the concerned parties. While alerts can be set at some job sites, the results they send are not very relevant. This is because the intelligence of the underlying systems is limited.

The invention we present, removes these disadvantages and thereby reduces the search time for both parties and at the same time improves the quality of search. With this invention we move to a system where seekers and providers don't have to search, they just have to specify what they are looking for in considerable detail and things will come directly to them.

### 4 BRIEF DESCRIPTION OF THE DRAWINGS

FIG. 1 illustrates the business process and the functionality of the system.

FIG. 2 illustrates the macro architecture of the system.

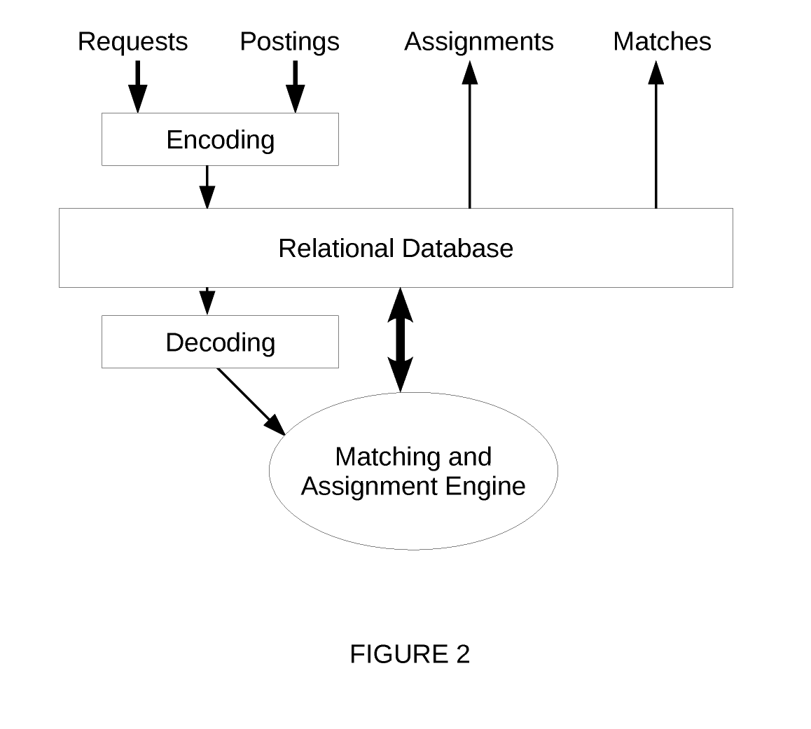

FIG. 3 illustrates the main assignment algorithm. More specifically it describes the setup of the network flow graph.

### 5 SUMMARY OF INVENTION

The invention consists of the following main components:
a business process for connecting seekers with providers which involves specifying attributes, preferences, uploading supporting documents and maintaining assignments created by the assignment engine.
a scoring method for match making, which uses two way matching and preference weighting to calculate a percentage match score.
a database framework for allowing users to add their unique attributes and preferences. This uses a string representation to store attributes and preferences.
A min cost max flow algorithm for assignment which minimizes mismatch.
An efficient method for updating assignments incrementally.

Each of these components is described in detail in the following section.

### 6 DETAILED DESCRIPTION OF INVENTION

### 6.1 Definitions

An item is something that can be sold (posted) or bought (requested). Examples of items include job, relationship, real estate for sale, used car for sale and venture funding. An item is defined by a set of attributes and their types and a set of preferences, their types and their default values. The preferences of the buyer are the attributes of the buyer and vice versa. There are no values assigned to the attributes or preferences in an item, they just define how the item should be described.
An item instance is an instance of the item. It is defined by the values assigned to some or all the attributes and preferences of the item. An item instance is either for sale by some member or is needed by some member.
A member is an individual or business, which either needs an item instance or wants to sell an item instance.
An attribute has a name, type and a value.
A preference has a name, type, value and a weight between 0 and 100.

### 6.2 Business Process

Both the seeker and provider follow the following steps to post an item instance:
1. Specify Attributes. An attribute describe what the seeker or provider has to offer. Each item has predefined attributes. Users can add new attributes if the existing ones are not enough. Attributes go through an approval process. However the system will show unapproved attributes in the suggestion box so that users do not add duplicate ones.
2. Specify Preferences. A preference specifies what the seeker or provider is looking for in the matching party. Each item has predefined preferences. Users can add new preferences if the existing ones are not enough. Preferences go through an approval process. However the system will show unapproved preferences in the suggestion box so that users do not add duplicate ones.
3. Upload Documents. Add an optional text description to describe the item instance and the expected match. Upload supporting documents, for example, photos, resume, car history report.
4. Engine Assigns. After the user has specified all the attributes and preferences and edited them for accuracy, he/she activates the item instance. At this point the item instance is scheduled for assignment. The assignment engine matches this item instance with relevant item instances incrementally and analyzes the supply demand and other constraints to assign the item instance to matching item instances. There is a redundancy in assignment. The redundancy is configurable for each item. If the redundancy number is i, the item instance is assigned to i item instances. The redundancy feature provides choices to the users fairly, while keeping the supply and demand as a constraint. The assignments change dynamically as the supply, demand or the item changes. This could happen because of the addition of an item instance, deletion (or deactivation) of an item instance, acceptance of an assignment or editing of an item instance.
5. Maintain Assignments. Users are expected to check their accounts regularly and take action on their assignments. If the user does not like an assignment he should reject it. Because the number of assignments are limited by the assignment redundancy number, the only way to get new assignments is to reject some of the existing assignments. This is very useful to the system, because it can assign the rejected item instance to some other item instance (user). A user can also mark an assignment as ‘under consideration’. If the user owning the ‘under consideration’ item instance (the matching party) has also marked this item instance ‘under consideration’, then the system will keep this assignment but it will continue to be assigned to other item instances as well. The user can also accept the assignment. If both parties accept the assignment, the matching process is complete and neither of the two item instances will be assigned to other item instances. The two matched parties can then communicate and choose the next step.
6. Communicate. The system provides a list of matches and a list of assignments. The matches are the top matches based on a two way match score whereas the assignments are based on the two way match scores as well as the supply and demand. We call the assignment a ‘perfect attainable match’. An assignment is done to both parties and is therefore is visible to both parties. Since both parties will have to look at the assignments, they are the best bet. A match on the other hand, only appears in the users list and may not appear in the matching party's list. However, the user can send a message to the matching party and see if they want to follow up. The user can also send message to an assigned item instance. After selecting the match, the two matched parties can communicate through the system anonymously and then can exchange personal information when they feel comfortable.

This business process has the following unique advantages:
1. Implicit Bidding. There is no explicit bidding, but the bidding happens implicitly. For example, when a sale item instance includes a price and the needed item contains a price range, the system will try to assign item instances within the price range, thereby selecting the ones that placed a lower bid. However, instead of just bidding, a lot more information can be specified through preferences and their priority, and the system will optimize based on that information.
2. A targeted Advertisement system. A sale item instance is a virtual advertisement. Because the sale item instance is assigned to the most relevant and available needed item instances, the advertisement automatically reaches the needed item instance. This introduces a new way of advertising where advertisers pay for reaching a targeted party instead of paying for a click.
3. Inherent privacy mechanism. Users can only send messages to either matched or assigned item instances. This introduces an inherent privacy mechanism. Since only matching parties can see the item instance, the item instance is visible to the intended viewers and not to the general public.

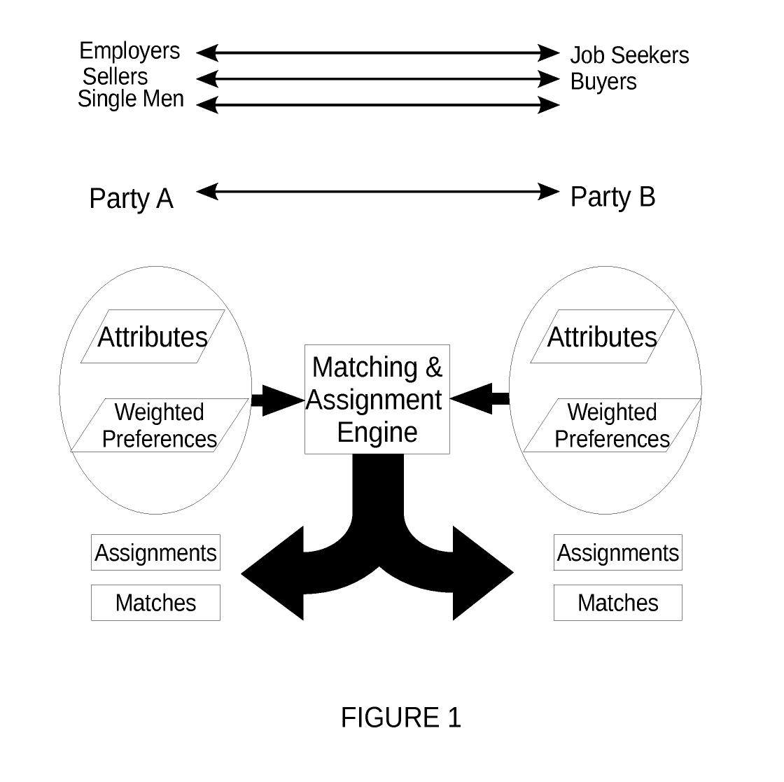

New items can also be added to the system. User added items as well as user added attributes go through an approval process. The business process is illustrated in FIG. 1.

### 6.3 Specification of Attributes and Preferences

The attributes or preferences can be one of the following types—an integer, an integer range, a boolean (yes/no), a string, a scale, a scale range, a choice, a list of integers, a list of strings, a list of choices. A preference has the same types as an attribute, but it also has a weight (priority) which allows the users to specify the relative importance of a preference. Preference weights range from 0 to 100 which gives users the flexibility for users to uniquely order up to 100 preferences. This general framework for attributes and preferences allow us to add any item to the system—e.g. job, relationship, real estate for sale, used car for sale, venture funding, real estate for rent etc.

When used as preference the attribute type is automatically converted as follows. An integer is converted to integer range, a string to a list of strings, a scale to a scale range, a choice to a list of choices. These conversion rules are logical and allow any newly added attributes to be used as preferences for the other party.

### 6.4 Calculation of Match Score

A two way match score is calculated between the sale item instance and the needed item instance. The preferences of the needed item are compared with the attributes of the sale item and a match score is computed. To compare an attribute and a preference they must have the same name. This is guaranteed by the system because the attributes of the sale item become the preferences of the needed item and vice versa. Then depending on the type of the attribute, we can determine whether there is a match or not. For example for a job instance, the employer attribute salary has a type integer range and the job seeker preference salary also has a type salary range. There is a match if the two salary ranges overlap. For integer based attributes—integer, integer range, scale, scale range, a partial match is also calculated. The partial match represents how far apart the matching values are. This allows the system to give more preference to matches that are close (even though they don't match). If there are n attributes and wᵢ denotes the weight of preference i, then the match score is computed as follows:
mᵢ=1 if preference i matches attribute i
mᵢ=0 if preference i does not match attribute i
0<mᵢ<0.5 if preference i partially matches attribute i

$$match = {\sum }_{i = 0}^{i = n} {w}_{i} {m}_{i}$$

$$maxMatch = {\sum }_{i = 0}^{i = n} {w}_{i}$$

$$matchScore = \frac{match}{maxMatch} \times 100$$

This accounts for 50% of the score. Then the preferences of the sale item are compared with the attributes of the needed item and a match score is computed in a similar manner. This accounts for the rest 50%.

The partial match score between integer based attributes is calculated as follows:

$${m}_{i} = \frac{1}{( 2 + \frac{valDiff}{maxRange} )}$$

valDiff is the minimum difference in the two values or ranges. For each integer type, a valid range is also specified and maxRange here denotes the maximum of the ranges for the two integer types being compared. This method guarantees that the value of mᵢ will be between 0 and 0.5.

### 6.5 Database Framework for Storing User Definable Attributes and Preferences

The main database tables that relate to attributes and preferences are:
Items table, which stores information about items
ItemInstances table which stores information about item instances
Choices table which stores the choices for a particular choice type.
Scales table which stores the information about scale types.

The system allows the users to add their unique attributes and preferences to the system.

This is a challenge for database design. If each attribute was to be stored as a field in a database table, new fields would have to be added every time a new attribute is added. And a new set of tables would have to be added each time a new item is added.

However, in this system we do not add new tables for every item. In order to allow maximum flexibility, the attributes and preferences are stored as string (varchar 5000) fields in the database (Items table). These strings have a well defined format. The attributes and preferences are first encoded into this format and then the string is stored in the database. While reading the database, the string is parsed to get the right values. The syntax of the attribute string is described below:

<attributeString> ::= {<singleAttribute>,}<singleAttribute>
<singleAttribute> ::= <rangedTypeAttribute> | <choiceTypeAttribute > | <basicAttribute>
<rangedTypeAttribute> ::= <basicAttribute>?<minVal>?<maxVal>
<choiceTypeAttribute> ::= <basicAttribute>?<choiceAttributeId>
<basicAttribute> ::= <attrType>?<attrUsageType>?<attrName>?<attrDesc>?<defaultPriority>

There are two string fields ‘attributes’ and ‘preferences’ in the items table, which contains one record for each item. Both the strings use the same syntax. The system will use either the attribute string or the preferences string, based on the type (sale or needed) of the item instance and whether it needs to create attributes or preferences. For example, for creating attributes for a needed item instance it will get the preferences string. To get create preferences of the needed item it will get the attribute string and convert the types according to the type conversion rules. For a sale item instance the strings would be switched, that is, it would use attribute string where it uses the preference string for the needed item.

The actual attributes with the values are stored in the item instance (in ItemInstances table). This is called either an attribute instance or a preference instance and the syntax for each of them follows:

<attributeInstanceString>:: {<singleAttributeInstance>,}
<singleAttributeInstance>
<singleAttributeInstance> ::= <attrName>?<attrValue>
<preferenceInstanceString>:: {<singlePreferenceInstance>,}
<singlePreferenceInstance>
<singlePreferenceInstance> ::= <priority>?<attrName>?<attrValue>

### 6.6 Assignment Algorithm

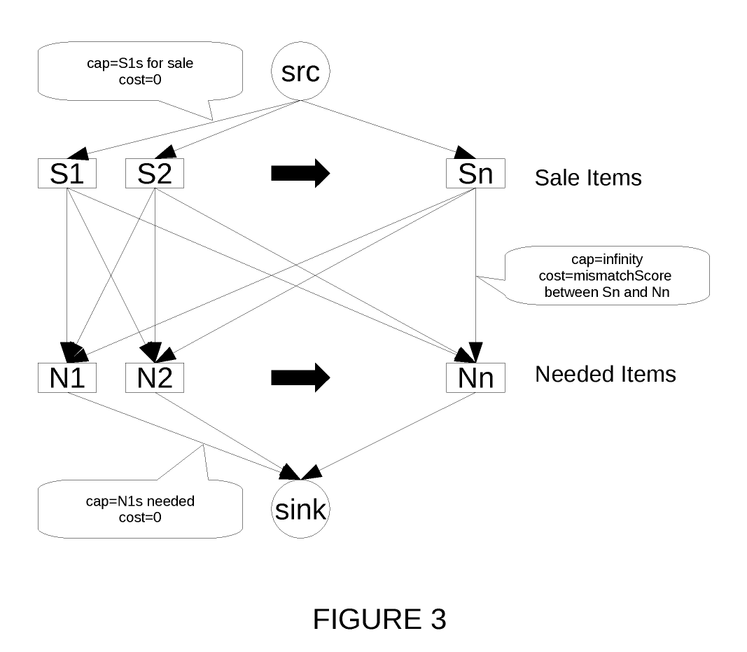

The assignment algorithm assigns items within a cluster. A cluster is a set of items of the same type which are close to each other and share a lot of attributes. The objective of the assignment algorithm is to minimize mismatch. In order to minimize mismatch, a flow graph is setup as illustrated in FIG. 3. The flow graph has a source, a sink and a vertex for each item instance in a cluster. The edges are inserted as follows:
For each item instance for sale Si, there is an edge from the src to Si. The capacity of this edge is equal to the number of Si available for sale and the cost is 0.
For each needed item instance Ni, there is an edge from Ni to sink. The capacity of this edge is equal to the number of Ni needed and the cost is 0.
There is an edge from Si to every allowed Ni, the capacity of this edge is infinite and the cost is equal to the mismatch score between the Si and Ni. Like the match score, the mismatch score is a percentage score. The mismatch score is calculated by subtracting the matchScore from 100. Some edges between Si and Ni may not be allowed. The reasons for this include rejection of Si by Ni or vice versa or legal reasons (e.g. relationship between an adult and a teen is not allowed).

The flow graph setup as above is solved to maximize flow at minimum cost (min cost max flow). After the flow, the sale items have been assigned to the needed items in such a way that the mismatch is minimized for the entire cluster. To realize the flow every edge between a Si and a Ni creates an assignment between the Si and Ni. A flow of 2 between Si and Ni would mean that two Si should be assigned to the Ni. If there is fractional flow, multiple edges leaving a vertex will have fractional flow and it will be assigned to the edge with the highest partial flow as long as there is enough capacity.

To allow for redundancy, the supply of all the sale item instances (Si) and the demand of all the needed item instances (Ni) is multiplied by the redundancy number of the item. As explained earlier, the redundancy gives users more choices while keeping the supply and demand constraint. If the imbalance between the supply and demand is high (the supply is more than twice the demand or demand is more than twice the supply), then the supply or demand of the outnumbered side can be scaled by a constant. This provides more choices to one side (the scarce), while still maintaining the fairness criteria.

### 6.7 Incremental Assignment

There are two approaches to incremental assignment:
Dynamic Clustering. In dynamic clustering, whenever an item instance (either needed or for sale) is added or modified (activation, deactivation, deletion, editing) a message s sent to the incremental assignment server with the item instance id. The incremental assignment server maintains a queue of item instances to be reassigned. In order to reassign the new item instance, a cluster is created dynamically by searching for all item instances of the same type (that is the same item) which are within a fixed distance (like 100 miles) from the new item instance. The new item instance and the searched item instances form belong to the dynamic cluster and this cluster is reassigned using the assignment algorithm described above. Other criteria like common attributes can be incorporated into the clustering algorithm but they will slow down the clustering process.
Static Clustering. In static clustering clusters are persistent. Clusters are stored in the database by associating a clusterId with each item instance. A change (activation, editing, deactivation, deletion) results in reassignment of the changed item instance to one of the clusters. It can also result in splitting of a cluster or merging of two clusters. The criteria for clustering include distance, common attributes and the size of the cluster. The size of the cluster is based on the number of item instances for which the assignment engine runs very fast (for our min cost network flow algorithm, a number below 5000 is ideal). The modified clusters are then passed to the incremental assignment server for reassignment. The incremental assignment server maintains a queue which contains the clusterId and the time of change. The queued clusters are then reassigned using the assignment algorithm described above. The server removes all entries of the cluster from the queue, before it starts the reassignment. This avoids any redundant runs of the incremental assignment engine.

Both clustering approaches have their advantages and disadvantages. The dynamic clustering approach is easier to implement and can produce better results. But it runs slow. Static clustering on the other hand is fast, but it is harder to implement and may not produce the best results because of the predetermined boundaries of the clusters.

1. A business process for assigning seekers to providers (that is two parties looking for each other) by looking at attributes and weighted preferences for both parties and the supply and demand.

2. An assignment algorithm for assigning seekers to providers which minimizes mismatch globally.

3. A min cost max flow algorithm for assignment which minimizes mismatch globally.

4. A scoring method for match making, which uses two way matching and preference weighting to calculate a percentage match score.

5. A scoring method which uses the difference between mismatched entries to increase granularity and break ties.

6. A method for supporting user defined columns in the database.

7. A method for claim 6 which uses fixed string columns which store a formatted string.

8. A method for incremental assignment of seekers and providers by using dynamic clustering using location information.
